(19) United States
(12) Patent Application Publication
(10) Pub. No.: US 2025/0328612 A1
(43) Pub. Date: Oct. 23, 2025

(54) SOFTWARE MANAGEMENT SYSTEM

(71) Applicant: The Court of Edinburgh Napier University, Edinburgh, Lothian (GB)

(72) Inventor: Pavlos PAPADOPOULOS, Edinburgh, Lothian (GB)

(73) Assignee: The Court of Edinburgh Napier University, Edinburgh, Lothian (GB)

(21) Appl. No.: 18/870,259

(22) PCT Filed: May 30, 2023
(86) PCT No.: PCT/GB2023/051427

§ 371 Date: Nov. 27, 2024

(30) Foreign Application Priority Data
May 31, 2022 (GB) 2208072.5

(51) Int. Cl. G06F 21/31

(52) U.S. Cl. CPC G06F 21/31

(57) ABSTRACT

A software management system comprising: a controller; a distributed ledger in communication with the controller, the distributed ledger comprising one or more records; and a set of software tools configured to be executed by the controller; wherein the controller is configured to: receive a software component; execute one or more software verification tools of the set of software tools, thereby producing a result; and store the result on a record of the distributed ledger.

### FIELD OF THE INVENTION

The present invention relates to a system and method for managing software. In particular, the present invention may provide a software and/or application security and/or supply chain management system and method.

### BACKGROUND TO THE INVENTION

Software products or systems often consist of several software components, each of which may be subject to influence or processing by multiple parties. For example, software components may be open source or closed source libraries or frameworks that the software product may utilise to operate. When a software update is applied to the software product, a manual verification of each component may first be performed to verify that the component is from a trusted source, followed by a manual security test. In software products having a large number of components, manual verification and testing may be unfeasible, particularly following a software update. Accordingly, software products may be vulnerable to cyber-attacks taking advantage of the difficulty present in verifying and testing the security of each component of the software products, and malicious code may be injected to exploit infected systems.

The way in which software products are developed may also be vulnerable to cyber-attacks. A party may develop code for a software component of a software product, and store it on a repository, such as a Git repository. The software product may be manually tested by performing a set of tests on the software component to verify various aspects, such as its security. This manual testing process may require a significant amount of time to complete for several reasons. These reasons may include the vast amount of application security tools available, the various scopes a software needs to be checked in order to be considered secure, and a lack of security expertise. The results of these tests are often shared via non-centralised means such as via emails, chat messages, or verbal discussion. This non-standardised means of communication may lead to difficulties in proving compliance with certain regulations (for example, GDPR regulations), and acquiring certifications such as ISO, Cyber essentials, and others, because the results of the tests need to be found manually by the respective regulatory organisation.

Furthermore, there may be significant challenges in mapping the results of these tests and/or actions carried out by people (e.g., software developers) with the repositories storing the respective software component code. Appropriately mapping the results and/or actions to the software components in this manner may require significant human input and may be overly time-consuming. Without mapping the results to the software components, it may be difficult to determine whether the software component has been verified.

After the tests are complete and the software component is verified and tested, the software component may be transmitted to, and stored on, a server. Additional parties, such as clients who intend to use the software product, may subsequently access and download the software component via the server. This may be repeated for a plurality of software components. A malicious party may insert malicious code into the verified, tested, and secure code of the software component when it is transmitted to the server. Therefore, additional parties who download the software component may download code comprising the malicious code.

In summary, the way in which software products are currently developed may lead to difficulties in producing secure and trusted software products. Developing secure and trusted software products is key for increasing the likelihood that software products or systems are not compromised, which may lead to potential functional, financial, or reputational losses for developers and companies that interact with software products. They may develop the software themselves, or outsource development of the software to a third party company.

The present disclosure has been devised to mitigate at least some of the above-mentioned problems.

### SUMMARY OF THE INVENTION

A software management system comprising: a controller; a distributed ledger in communication with the controller, the distributed ledger comprising one or more records; and a set of software tools configured to be executed by the controller; wherein the controller is configured to: receive a software component; execute one or more software tools of the set of software tools, thereby producing a result; and store the result on a record of the distributed ledger.

As used herein, a software component may refer to a modular component of a software product. The software component may be a software package, a web service, or a module that provides a function to the software product.

As used herein, a distributed ledger may refer to a database spread across several nodes on a network, wherein each node saves a copy of the distributed ledger and updates itself independently following the same set of rules such that if all the nodes operate normally, they should conclude the same update or result. The distributed ledger may be, for example, a blockchain-based ledger. As used herein, a record of the distributed ledger may refer to an entry of the distributed ledger. Records may be stored one after the other in a continuous manner.

As used herein, a software tool refers to a system or platform for execution on a software component. The set of software tools may comprise one or more verification tools and/or one or more testing tools. A software verification tool may be configured to verify the software component and provide a verification result of the verification. A software testing tool may be configured to test the software component and provide a security test report of the test. The software tool may provide a negative result indicative of the software component being unverified, unsecure, not performance efficient, or any other relevant result.

The skilled person will appreciate that the controller may be configured to execute as many of the set of software tools as is required for a particular software product or system. For example, in some embodiments, only a single software tool is required to be executed, whilst in others, some or all of the software tools are required to be executed.

The software management system may provide a means for storing reports and/or results provided by a variety of software tools, as required by a particular organisation's requirements. The reports may be stored on a record of a distributed ledger. Advantageously, the present system may provide a means for preventing tampering of the reports stored on records of the distributed ledger. Furthermore, the present system may advantageously provide a more trustworthy and transparent software supply-chain. In particular, the present system may provide a means for providing proof to external third parties that all necessary steps have been taken to secure the software component. Additionally, the present system may provide a means for proving to regulators that all necessary security actions have been employed in the event of a security breach.

Furthermore, the system may be integrated with existing systems of a software product or system having one or more software components via one or more APIs. The system may also be integrated with Continuous Integration/Continuous Development infrastructures and also with other software verification tools, security testing tools, unit testing tools, performance testing tools, software code repositories such as GitHub, and other “Issue & Project Tracking Software” systems such as Jira, chat platforms such as Slack/Teams or other CRMs. Advantageously, the system may provide a means for automating all testing required of the software product or system such that a final version of the software product or system is as secure and/or bug-free as necessary to meet a criteria.

In some embodiments, the controller is further configured to, in response to an interaction with the software component: execute one or more software tools of the set of software tools, thereby producing a new result; and store the new result on the record of the distributed ledger. The interaction with the software component may be any interaction that alters the software codebase associated with the software component. For example, the interaction may correspond to a new portion of code introduced to the software codebase of the software component, or existing code being amended. Thus, the present system may provide a means for dynamically testing the software component as it is edited or changed.

In some embodiments, the controller is also configured to store test metadata associated with the result on the record of the distributed ledger. The test metadata may comprise one or more of: a set of performed actions; an interacting party identifier; a developer identifier; a merging party identifier; and an approval party identifier. The set of performed actions may provide an indication of the actions performed on the software component. For example, the actions performed on the software component may include an edit, a pull request, or any other actions associated with the software components. The interacting party identifier may provide an indication of the identity of a party that has interacted with the software component, for example by uploading a new portion of code to the software codebase and/or editing the software codebase. The developer identifier may provide an indication as to the identity of the developer who developed the software component. The merging party identifier may provide an indication as to the identity of the party who committed the code of the software component to the software product codebase. The approval party identifier may provide an indication as to the identity of the party who approved the merge of the committed code to the software product codebase. In this way, the record of the distributed ledger may also provide information relating to the parties involved with the merging of the software component with the software product codebase, and/or the uploading of new code to the software codebase.

By including the interacting party identifier in the record of the distributed ledger, the present system may provide a means for identifying an interacting party that has, for example, caused a negative test result, such as the software component being unverified, unsecure, not performance efficient, or any other relevant result. Furthermore, an interacting party identifier may indicate that a negative test result has occurred as result of an interaction by an external cause that is out of a user's control, for example when the interacting party identifier is an indicator that does not match identifiers associated with a primary party. Thus, a party utilising the present system may easily prove that it has taken all necessary actions to secure the software component. Furthermore, if an issue arises at a later date that is outside of the control of the party, the party can prove that they were not at fault. For example, the party using the system may have a result stored in the record of the distributed ledger that is indicative of the software component being secure (i.e., no vulnerabilities were found). A future execution of the one or more software tools, for example if the software codebase is attacked, may result in an update to the record indicative of there being a vulnerability and/or some form of data leakage. The interacting party identifier may serve as a means for the party using the system to prove that the vulnerability was outside of their control, and that they had ensured that their software component was safe. Potentially, this may serve as evidence that may be used to reduce fines and/or penalties by regulators and other parties.

The interacting party identifier may also provide a means for the party using the system to track what is going on with the software codebase of the software component. For example, whether a member of their party is fixing an identified vulnerability.

Providing test metadata may also advantageously facilitate the standardisation of information and/or data associated with the software product, whilst also improving transparency of the software supply chain. In the situation wherein the system is integrated with existing systems of a software product or system having one or more software components, the system may advantageously provide an automated means for collecting and storing relevant information to a centrally managed platform.

In some embodiments, the controller is further configured to store mapping metadata on the record of the distributed ledger. The mapping metadata may comprise: data indicative of a storage location of the software component. The storage location of the software component may be a repository on which a software codebase of the software component is stored. In this way, the results of the one or more software tools may be automatically mapped to the storage location of the software codebase.

The controller storing the mapping metadata and the test metadata on the same record of the distributed ledger may advantageously provide a means for automatically mapping the findings or results of the software verification and software testing tools. Accordingly, the present invention may provide a means for addressing present challenges with mapping results and/or actions to the software components, thus saving time and resources.

The controller may store timestamp metadata alongside the test metadata and/or the mapping metadata in the record of the distributed ledger. The timestamp metadata may represent timestamp data received and/or collected from the software repository storing the software codebase of the software component and/or the one or more software tools. In this way, the present invention may provide a timeline of actions taken according to these timestamps and/or parties involved in carrying out said actions. The timestamp data may provide a means for easily viewing when interactions with the software component have occurred. For example, in the case of an action being taken to secure the software component following a result indicative of there being a vulnerability, the timestamp data may provide a means for indicating when the securing action was taken.

In some embodiments, the controller is configured to map a first action to a first party. The first action may be the introduction of a particular portion of code to the software codebase and/or the editing of existing code of the software codebase. The first party may be the party that has uploaded said portion of code the software codebase. Thus, if a software tool is executed with respect to the software component comprising the introduced portion of code and determines that a software vulnerability is present, the system may provide a means for identifying the party who uploaded or introduced the portion of code.

In some embodiments, the system further comprises a second platform. The second platform may be a project management tool. The project management tool may be understood as a tool or system for tracking bugs, such as Jira, Asana, and/or any other suitable tool, system, or platform.

In some embodiments, the controller is configured to generate an alert and/or a ticket based on the result of the one or more software tools; and transmit the alert and/or ticket to the second platform. In some embodiments, the alert is indicative of a negative result. For example, if, following execution of a software testing tool, a result is produced indicative of there being a vulnerability, a bug, or any other negative result, the controller may generate an alert based on this negative result. In some embodiments, the ticket is representative of there being an issue to be resolved. Thus, the present invention may provide a means for automatically generating tickets and/or alerts based on identified software issues (such as vulnerabilities, bugs, and other issues), and transmitting the alert or ticket to other project management tools, ticketing systems, and/or any suitable platform used to assist in the development of software code. A user of the present system may respond accordingly. For example, the user may subsequently interact with the code by amending the code to fix a vulnerability. This interaction may then cause the controller to execute the one or more software tools to provide a new result, which may be stored on the record of the distributed ledger. Accordingly, the present system may provide a means for proving to third parties, such as regulators, that necessary security actions have been employed in the event of a test result indicative of a security breach, for example; when malicious code has been upload to the software codebase of the software component.

In some embodiments, the alert and/or ticket comprises the test metadata. Accordingly, the alert and/or ticket may include information about the developer who introduced a software portion to the software codebase, the developer who reviewed the software code, and the developer who accepted the software update to be merged into the main codebase for further insights and auditing purposes.

In some embodiments, the system further comprises a user device comprising a display. In some embodiments, the system is configured to display on the display of the user device, the alert.

In some embodiments, the controller is configured to determine that an existing ticket corresponding to the result is present on the second platform. Thus, the present system may provide a means for determining whether an existing ticket is present in the second platform.

In some embodiments, the controller is configured to, in response to the determination that an existing ticket is present on the second platform, display on the display of the user device an indication that there is an existing ticket corresponding to the result on the second platform.

Accordingly, by displaying the alert or the indication that there is an existing ticket corresponding to the result on the second platform, the present system may assist in the tracking of actions that are taking place on the system.

In some embodiments, the controller is further configured to: receive an access request from a party; determine an access permission associated with the party; and provide the party access to one or more records of the distributed ledger based on the first access permission. The party may be an external auditor associated with providing a certification, such as a certificate related to an organisation's operation and compliances (ISO, GDPR, Cyber Essentials and others). Alternatively, the party may be an end-user of the software product. Further alternatively, the party may be a client, a customer, an individual, another organisation, a partner, or any other suitable party. In this way, the present system may provide a means for facilitating and controlling access to information stored on the distributed ledger, depending on the party requesting access to the distributed ledger. Advantageously, acquiring a certificate for the software product or system may become easier as relevant information may be more easily accessed by auditors. Additionally, the information may be more trustworthy, which may further increase the ease of acquiring a certificate. The system may further advantageously facilitate customer on-boarding by providing the customer with assurance that the organisation followed all the security actions it could take to protect their software.

In some embodiments, the controller is further configured to transmit and store the software component on an application server following execution of the one or more software tools.

In some embodiments, the controller is configured to transmit the software component via an end-to-end encrypted channel.

In some embodiments, the controller is further configured to: receive a user credential from an external party; and provide access to the software component on the application server based on the user credential. The user credential may be an identifier such as a decentralised identifier (DID). The user credential may be a verifiable credential (VC). In this way, the system may advantageously provide a means for providing an external party, such as an end-user, access to the software component in a secure manner. Furthermore, the DID and VC may be used to verify that the each party is who they claim to be (e.g. a developer is the legitimate developer, a client is the legitimate client, etc.).

In some embodiments, the controller provides access to the software component by verifying that the user credential is present on an identities ledger. In particular, the user credential may be stored on an immutable public ledger, such as an immutable blockchain-based ledger, in which a legitimate authority controls the entries. However, the skilled person will appreciate that the identity verification means is agnostic to the present system and the user credential may be stored on any suitable storage means, including a private local database such as a PostgreSQL database. In this way, the controller may provide access to the software component based on the presence of information representative of the user credential in the identities ledger. That is, the controller may verify that the external party holds a user credential verified by a legitimate authority. Accordingly, the system may advantageously provide a means for providing an external party, such as an end-user, access to the software component in a more secure manner.

In some embodiments, the set of software tools comprises one or more of: a unit testing tool; a performance testing tool; a certification tool; and a security scanning tool.

In some embodiments, the controller stores the result on the distributed ledger via an application programming interface (API). Advantageously, the API may facilitate integration of the present system with an existing system of a software product or system such that the result and metadata are stored in a specific system, the distributed ledger.

In some embodiments, the controller is configured to: generate a recommendation; and transmit the recommendation to a user device. The recommendation may be a recommendation comprising suggestions for enhancing the security of the software. In some embodiments, the recommendation is generated using a Machine Learning model, Natural Language processing, Artificial Intelligence, or any other suitable data analysis method or technique. The recommendation may be based on common best coding practices by other providers such as NIST's Secure Software Development Lifecycles, ISO and SOC2 certifications. The Machine Learning model, Natural Language processing, and/or Artificial Intelligence may take as input all information collected by the present system and output a recommendation based on trained models based on the aforementioned coding practices.

Thus, the present invention may provide a system that stores interactions with the software codebase of the software component on a tamper-proof distributed ledger. The system may also advantageously provide a timeline of all interactions taken, the parties involved in said interactions, and recommendations for enhancing the security of the software component. Moreover, the system may provide that no entity is able to bypass the set cryptographically-secure mechanisms, modify one of the stored results, and/or modify or “hide” actions taken by a specific person or team of developers.

In some embodiments, the controller is configured to divide one or more parties into one or more groups based on characteristics of the one or more parties. The one or more parties may be one or more separates parties that use the system. The characteristics used to divide the one or more parties into one or more groups may be libraries used by the one or more parties. For example, the controller may divide one or more parties that use ‘X’ library into a first group, one or more parties that use ‘Y’ library into a second group, and so on. The system and the one or more parties may not be able to view or determine which group they belong to.

In some embodiments, the controller is configured to, in response to a negative result of the software component stored in a first library, transmit a notification to a group associated with the first library. For example, if a negative result is determined for the software component and the software component is part of the first library, such as ‘X’ library, the controller may transmit a notification to one or more parties of the group associated with ‘X’ library. In this way, one or more parties affected by the negative result may be notified without the identity of other parties affected by the negative result being revealed. It may be noted that characteristics of the parties may not be identified by the system or any other party in situations where a negative result is determined for the software component. Thus, privacy of the parties may be preserved. Furthermore, privacy of the parties may be preserved even when no negative result is determined for the software component, because characteristics of the parties are not identified or known by the system or other parties.

In some embodiments, the controller is configured to transmit the alert to the second system via an API.

In accordance with a second aspect of the present disclosure, there is provided a software management method comprising: receiving, by a controller, a software component; executing, by the controller, one or more software tools of the set of software tools, thereby producing a result; storing, by the controller, the result on a record of the distributed ledger.

In some embodiments, the method further comprises: executing one or more software tools of the set of software tools, thereby producing a new result; and storing the new result on the record of the distributed ledger.

In some embodiments, the method further comprises: storing, by the controller, metadata related to verification and/or testing associated with the result on the record of the distributed ledger.

In some embodiments, the test metadata comprises one or more of: a set of performed actions; a developer identifier; a merging party identifier; and an approval party identifier.

In some embodiments, the method further comprises: storing, by the controller, mapping metadata on the record of the distributed ledger.

In some embodiments, the method further comprises: receiving, by the controller, an access request from a party; determining, by the controller, an access permission associated with the party; and providing, by the controller, the party access to one or more records of the distributed ledger based on the first access permission.

In some embodiments, the method further comprises: transmitting and storing the software component on an application server following execution of the one or more software tools receiving, by the controller, an access request from a party.

In some embodiments, the controller is configured to transmit the software component via an end-to-end encrypted channel.

In some embodiments, the method further comprises: receiving, by the controller, a user credential from an external party; and providing, by the controller, access to the software component on the application server based on the user credential.

In some embodiments, the controller provides access to the software component by verifying that information representative of the user credential is present on a public ledger.

In some embodiments, the set of software tools comprises one or more of: a unit testing tool; a performance testing tool; a certification tool; and a security scanning tool.

In some embodiments, the result is stored on the distributed ledger via an API.

In some embodiments, the method further comprises: generating an alert based on the result of the one or more software tools; and transmitting the alert to a second system.

In some embodiments, the alert is transmitted to the second system via an API.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims

### BRIEF DESCRIPTION OF THE DRAWINGS

The invention will now be described by way of example only with reference to the following Figures in which:

FIG. 1 shows a systematic view of a first embodiment of a software management system according to a first aspect of the present disclosure;

FIG. 2 shows a flow diagram of a software management method using the first embodiment of the software management system, according to a second aspect of the present disclosure;

FIG. 3 shows a systematic view of a second embodiment of the software management system according to a first aspect of the present disclosure; and

FIG. 4 shows a flow diagram of a software management method using the second embodiment of the software management system, according to a second aspect of the present disclosure.

### DETAILED DESCRIPTION

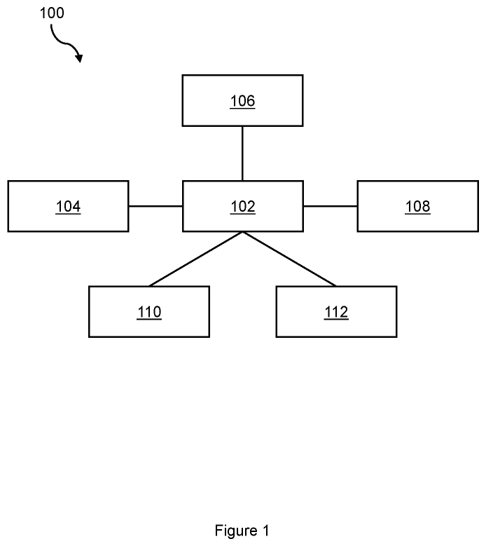

FIG. 1 is a schematic view of a software management system 100 according to a first aspect of the present disclosure. The system 100 is configured to provide a connected software supply-chain for a software product or system, the software product or system comprising one or more software components. In particular, the system 100 is configured to facilitate the verification of the software components, facilitate data storage, and facilitate the execution of smart contracts.

The system 100 comprises a controller 102, a software component datastore 104, a distributed ledger 106, one or more software tools 108, and a developer interface 110. The system 100 may also comprise further components as is known in the art, such as receivers, routers, transmitters, and processors.

The controller 102 is in communication with the software component datastore 104, the distributed ledger 106, the software tools 108, the developer interface 110, and the user interface 112. The controller 102 may include one or more devices (not shown), such as a router, a server, and a workstation.

The controller 102 is configured to receive a software component from a party, such as a developer of the software component via the developer interface 110. The controller 102 is also configured to store the received software component on the software component datastore 104. The controller 102 is also configured to automatically execute one or more of the one or more software tools 108 on the software component when certain conditions are met. The processor 102 is also configured to write data to the distributed ledger 106. The controller 102 is also configured to manage access to the distributed ledger 106 via the user interface 112.

The software component datastore 104 is configured to store a software component. The software component datastore 104 is also configured to store a codebase of a software product or system. The software component datastore 104 may be a software repository, such as a Git repository.

The distributed ledger 106 is a database spread across several nodes on a network and may be, for example, a blockchain-based ledger. The distributed ledger 106 comprises one or more records. Each record may be linked to pre-existing records. That is, each record may include a reference to previous records of the distributed ledger 106.

In some embodiments, the distributed ledger 106 also comprises one or more smart contracts. The smart contracts are defined and implemented by according to the software recipient or customer's needs. The smart contracts are configured to automatically execute one or more software tools 108.

In the present example, the one or more software tools 108 comprise a set of software verification tools configured to verify a software component, and a set of software testing tools configured to test a software component, and provide a verification result and a report of the test, respectively. The set of software tools 108 comprises: a unit testing tool; a performance testing tool; a certification tool; and a security scanning tool. The unit testing tool is configured to, when executed, determine whether a software component is fit for use.

The performance testing tool is configured to, when executed, determine how a software component performs under particular workload. The certification tool is configured to, when executed, determine whether a software component meets a set of criteria for a certificate, such as a report regarding GDPR regulation, or a report regarding an ISO/Cyber Essentials certification, or any other suitable certificate or report. The security scanning tool is configured to, when executed, determine a presence of vulnerabilities of a software component, software coding mistakes, bad security practices, usage of untrusted software components, usage of outdated software components, and/or usage of software components that cause conflicts with other used software components.

The skilled person will understand that the above list of software tools 108 is not exhaustive, and that further software tools 108 may be envisaged, such as integration testing tools, functional testing tools, and acceptance testing tools.

The developer interface 110 is configured to provide an interface for a developer to submit a software component to the system 100. That is, when a developer intends to submit a software component to the software product, or submit a portion of code to a codebase of the software product, the developer interface 110 provides a means for doing so.

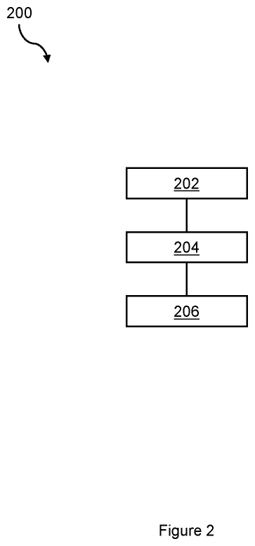

FIG. 2 is an example software management method 200 using the software management system 100 of FIG. 1.

In a first step 202, the controller 102 receives a software component. The software component may be received by a router (not shown) of the controller 102. The software component is a component of a software product or system, which facilitates operation of the software product. The software component is configured to be used with other software components of the software product. In the present example, the software component is developed by a first developer.

The controller 102 receives the software component in response to the first developer submitting the software component to the system 100 via the developer interface 110, for example following the merging of the software component with a codebase of the software product by the first developer.

The controller 102 may receive the software component via a secure communication channel configured to prevent any external parties from reading, or intercepting, a communication comprising the software component. The secure communication channel may be an encrypted communication channel. For example, the encrypted communication channel may be established through a Decentralised Identifiers Communication Protocol or any other method to facilitate end-to-end encryption and/or establish an end-to-end encrypted channel.

In an optional step 203, the controller 102 stores the software component in the software component datastore 104.

In step 204, the controller 102 executes a software test tool of the set of software tools 108 on the software component, thereby generating a result. For example, the controller 102 may execute the vulnerability scanner on the software component, thereby generating a test result report. It will be understood that the term “test result report” means a result, or a set of data, generated following the execution of the software test tool. The result may be a verification result if a software verification tool is executed.

In an alternative step 204, the one or more smart contracts of the distributed ledger 104 execute a software tool of the set of software tools 108 on the software component to generate a result.

In an optional step 205, for example in instances wherein a result is indicative of the software component being unverified, unsecure, not performance efficient, or any other relevant result, the processor transmits a notification to the first developer notifying them of the result.

In step 206, the controller 102 stores the result on a record of the distributed ledger 106. In an alternative step 206, the one or more smart contracts of the distributed ledger 106 stores the result on a record of the distributed ledger 106.

Steps 204 and 206 are repeated for as many of the software verification tools and software testing tools of the set of software tools 108 as is required for the software component. In some embodiments, all required software tools 108 are executed prior to step 206. In some embodiments, the software tools 108 are executed according to step 204, and the results are stored according to step 206, sequentially.

The method 200 may be repeated for software components submitted by one or more second developers.

Additionally, the method 200 is repeated if the first developer re-submits the software component, for example following a verification result that is indicative of the software component being unverified. In this instance, a new version of the software component is stored in the software component datastore 104 in optional step 203.

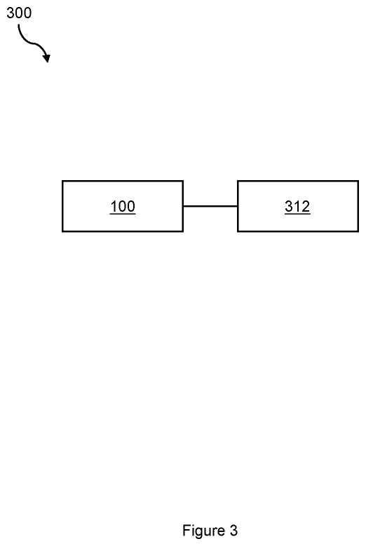

FIG. 3 is a second embodiment 300 of the software management system according to a first aspect of the present disclosure. The system 300 is configured to facilitate access to a software supply-chain for a software product or system, the software product or system comprising one or more software components. In particular, the system 300 is configured to facilitate access to data stored on the distributed ledger 106.

The system 300 is similar to the system 100 in that it comprises at least the controller 102, the distributed ledger 106, the one or more software tools 108, and the developer interface 110. The system 300 may also comprise further components as is known in the art, such as receivers, routers, transmitters, and controllers.

The system 300 also comprises a user interface 312. The user interface 312 is configured to provide an interface for a party to query the distributed ledger 106. That is, when a party such as an auditor requests access to one or more records of the distributed ledger 106, the user interface 312 provides a means for doing so.

The records of the distributed ledger 106 in the system 300 each have a list of access credentials. The list of access credentials comprises predetermined entries, but is dynamically updated so as to include additional entries so as to provide access to additional parties.

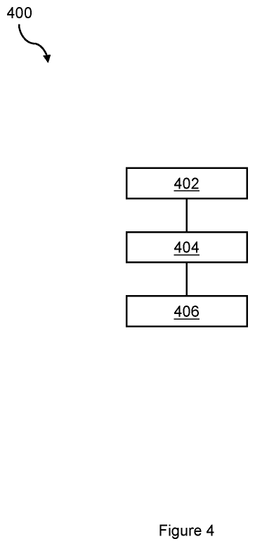

FIG. 4 is an example software management method 400 using the software management system 300 of FIG. 3. The method 400 provides a means for providing access for a party to one or more records of the distributed ledger 106, depending on an access permission associated with the party. The method 400 may also provide a means for accessing and utilising other components of the system 100.

The method 400 will be described with respect to a first party, such as an auditor, having a first access permission, and a second party, such as a client, having a second access permission. In this example, the first access permission is representative of a greater level of access than the second access permission. That is, the first party (i.e. the auditor) is to have a greater level of access than the second party (i.e. the client) such that the first party is able to access more data of a record.

The first party and the second party each have a respective identifier and/or respective credential.

In a first step 402 of the method 400, the controller 102 receives an access request from a party. In particular, the party requests access to a record of the distributed ledger 106. The party may also request access to other components of the system 100.

In a second step 404 of the method 400, the controller 102 determines an access permission associated with the party. In particular, the controller 102 compares the respective identifier and/or credential to the pre-determined list of access credentials. In the present example, the pre-determined list of access credentials comprises an indication that the first party is able to access all data stored on the record, whilst the second party is only able to access results from the one or more software tools 108.

In a third step 406 of the method 400, the controller 102 provides access to one or more records of the distributed ledger 106 based on the first access permission.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A software management system comprising:
a controller;
a distributed ledger in communication with the controller, the distributed ledger comprising one or more records; and
a set of software tools configured to be executed by the controller;
wherein the controller is configured to:
receive a software component;
execute one or more software tools of the set of software tools, thereby producing a result; and
store the result on a record of the distributed ledger.

2. The system of claim 1, wherein the controller is further configured to, in response to an interaction with the software component:
execute one or more software tools of the set of software tools, thereby producing a new result; and
store the new result on the record of the distributed ledger.

3. The system of claim 1, wherein the controller is also configured to store test metadata associated with the result on the record of the distributed ledger.

4. The system of claim 3, wherein the test metadata comprises one or more of:
a set of performed actions;
an interacting party identifier;
a developer identifier;
a merging party identifier; and
an approval party identifier.

5. The system of claim 3, wherein the controller is further configured to store mapping metadata on the record of the distributed ledger.

6. The system of claim 1, wherein the controller is further configured to:
receive an access request from a party;
determine an access permission associated with the party; and
provide the party access to one or more records of the distributed ledger based on the first access permission.

7. The system of claim 1, wherein the controller is further configured to transmit and store the software component on an application server following execution of the one or more software tools.

8. The system of claim 7, wherein the controller is configured to transmit the software component via an end-to-end encrypted channel.

9. The system of claim 7, wherein the controller is further configured to:
receive a user credential from an external party; and
provide access to the software component on the application server based on the user credential.

10. The system of claim 9, wherein the controller provides access to the software component by verifying that the user credential is present on an identities ledger.

11. The system of claim 1, wherein the set of software tools comprises one or more of:
a unit testing tool;
a performance testing tool;
a certification tool; and
a security scanning tool.

12. The system of claim 1, wherein the controller stores the result on the distributed ledger via an API.

13. The system of claim 1, wherein the controller is configured to:
generate an alert based on the result of the one or more software tools; and
transmit the alert to a second system.

14. The system of claim 13, wherein the controller is configured to transmit the alert to the second system via an API.

15. A software management method comprising:
receiving, by a controller, a software component;
executing, by the controller, one or more software tools of the set of software tools, thereby producing a result; and
storing, by the controller, the result on a record of the distributed ledger.

16. The method of claim 15, further comprising:
executing one or more software tools of the set of software tools, thereby producing a new result; and
storing the new result on the record of the distributed ledger.

17. The method of claim 15, further comprising: storing, by the controller, test metadata associated with the result on the record of the distributed ledger.

18. The method of claim 17, wherein the test metadata comprises one or more of:
a set of performed actions;
a developer identifier;
a merging party identifier; and
an approval party identifier.

19. The method of claim 17, further comprising: storing, by the controller, mapping metadata on the record of the distributed ledger.

20. The method of claim 15, further comprising:
receiving, by the controller, an access request from a party;
determining, by the controller, an access permission associated with the party; and
providing, by the controller, the party access to one or more records of the distributed ledger based on the first access permission.

21. The method of claim 15, further comprising: transmitting and storing, by the controller, the software component on an application server following execution of the one or more software tools.

22. The method of claim 21 wherein the controller is configured to transmit the software component via an end-to-end encrypted channel.

23. The method of claim 21, further comprising:
receiving, by the controller, a user credential from an external party; and
providing, by the controller, access to the software component on the application server based on the user credential.

24. The method of claim 23, wherein the controller provides access to the software component by verifying that information representative of the user credential is present on an identities ledger.

25. The method of claim 15, wherein the set of software tools comprises one or more of:
a unit testing tool;
a performance testing tool;
a certification tool; and
a security scanning tool.

26. The method of claim 15, wherein the result is stored on the distributed ledger via an API.

27. The method of claim 15, further comprising:
generating an alert based on the result of the one or more software tools; and
transmitting the alert to a second system.

28. The method of any of claim 27, wherein the alert is transmitted to the second system via an API.
